(19) United States
(12) Patent Application Publication
(10) Pub. No.: US 2010/0023485 A1
(43) Pub. Date: Jan. 28, 2010

(54) Method of generating audiovisual content through meta-data analysis

(76) Inventor: Hung-Yi Cheng Chu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/179,585

(22) Filed: Jul. 25, 2008

(51) Int. Cl. G06F 17/00; G06F 17/30

(52) U.S. Cl. 707/3; 715/203; 707/E17.014

(57) ABSTRACT

To provide fast, robust matching of audio content, such as music, with visual content, such as images, videos, and text, a keyword is extracted from either the audio content or the visual content. The keyword is then utilized to match the audio content with the visual content, or the visual content with the audio content. The keyword may also be utilized to find other related keywords for expanding the amount of visual content or audio content matched. The matched audio and visual content may also be mixed to generate audiovisual content, such as a presentation or slideshow with background music.

### BACKGROUND OF THE INVENTION

1. Field of the Invention

The present invention relates to methods for generating audiovisual content, and particularly, to a method of generating audiovisual content through meta-data analysis of audio and visual materials.

2. Description of the Prior Art

New digital audiovisual content, such as digital photographs, digital music, and digital video, is being created, stored, modified, and shared online at an unprecedented rate. Most computer users now have entire libraries of personal photos, favorite songs or albums, home videos, and downloaded or recorded broadcasts, including news, movies, and television shows. As the libraries increase in size, making it harder for users to find the exact file they are looking for at any given moment, meta-data are included in the digital files to aid in categorizing the digital files. The meta-data may indicate author, date, title, genre, and other such characteristics of each photograph, song, document, or video, so that the user may simply filter out all songs by a particular artist, or all photographs taken within a range of dates.

Video editing applications provide the user with a way to integrate the digital content mentioned above to generate new audiovisual content, such as photo slideshows, or presentations with video clips, quotes, and background music. The user may spend hours selecting photos and video clips, cropping or editing the photos and video clips, and finding appropriate background music. This makes most video editing a daunting task for the casual user, and wastes precious time for professional users.

### SUMMARY OF THE INVENTION

According to an embodiment of the present invention, a method of matching audio content with visual content comprises extracting a keyword from the audio content, and matching the visual content to the audio content when the keyword corresponds to the visual content.

According to another embodiment of the present invention, a method of matching visual content with audio content comprises extracting a keyword from the visual content, and matching the audio content to the visual content when the keyword corresponds to the audio content.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a method of matching audio content with visual content according to an embodiment of the present invention.

FIG. 2 is a diagram of a method of matching visual content with audio content according to another embodiment of the present invention.

### DETAILED DESCRIPTION

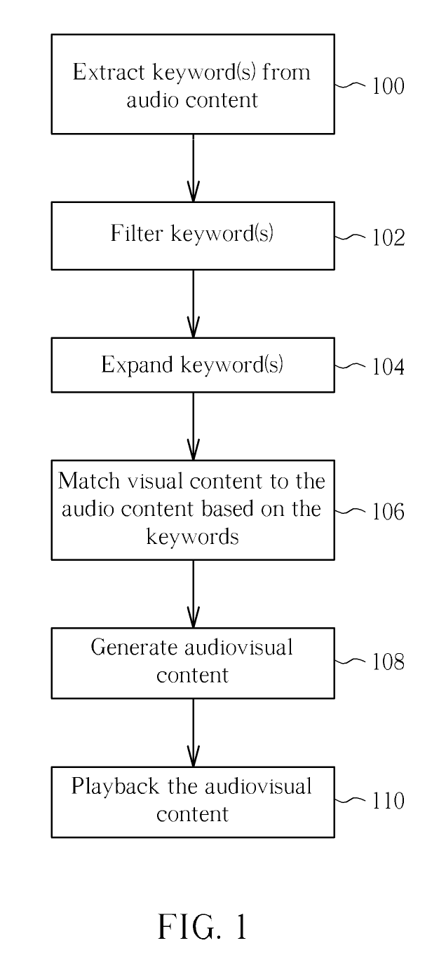

Please refer to FIG. 1, which is a diagram showing a method of matching audio content with visual content according to an embodiment of the present invention. The method may be utilized in a networked or non-networked computing device or mobile device for matching audio content, such as music files, with visual content, such as image files, video clips, and text. The audio content may be a streaming audio file or a static audio file, and may reside on a local storage device or an optical medium, such as a CD, VCD, DVD, BD, or HD-DVD. Likewise the visual content may be a streaming video file, a static video file, or a static image file, and may reside on a local storage device or an optical medium, such as a CD, VCD, DVD, BD, or HD-DVD. The visual content may also be text-based, such as lyrics, or a quote.

Given the audio content, such as an MP3 file containing meta-data, a keyword (or keywords), is extracted from the MP3 file (Step 100). The keywords may be extracted by decoding the audio content, and reading the text information of the meta-data. For example, the keywords may be a title, an artist, a genre, a year, an album, comments, a tag of the audio content, or a combination thereof, extracted from the audio content. In a particular embodiment, the above-mentioned metadata for extraction are encoded into an ID3 file in conjunction with the MP3 file. The keywords may also be found in an Internet-downloaded file or disc info data retrieved from an online database, such as audio CD track information downloaded from CDDB, DVD movie information downloaded from AMG, or lyrics downloaded from an online lyrics site. The keywords may also be user-inserted tagging text found in a local storage device, such as file tags in a media library, or other tags in proprietary applications. Other possible sources for the keywords are user comments or tags in online services, such as editor's tags in Flickr. The keywords may also be found in text-based information that may not be extracted by decoding, and may require proprietary applications, specifications, and tools to extract.

Once the keywords have been extracted, the keywords may be filtered (Step 102) according to a vocabulary database comprising a plurality of poor keywords that may lead to imprecise search results and should be avoided during match-up processes. If any of the keywords matches one of the poor keywords, the matching keyword(s) may be removed, leaving one or more keywords for use in matching the visual content.

The keywords may also be expanded (Step 104) by inputting the keywords to an Internet-based service or a proprietary software application to find related keywords. Or, the keywords may be looked up in a vocabulary database to find the related keywords. If the related keywords are found through the Internet-based search service or the proprietary software application, the related keywords may also be filtered through the vocabulary database as mentioned above (Step 102). The vocabulary database may contain cross-referenced tables of words used for similar occasions, words used in conjunction, words used to imply similar characteristics, or words that are synonyms. The vocabulary database may be static, editable, and/or Internet-residing, and may be the same or different from the vocabulary database utilized for performing Step 102. Please note that Steps 102 and 104 need not be performed in the order shown in FIG. 1. In other words, Step 104 (expanding the keywords) may be performed before Step 102 (filtering the keywords). However, performing Step 102 may be beneficial for obtaining relevant related keywords before expanding the keywords in Step 104.

Utilizing the keywords, and optionally the related keywords, the visual content may be matched with the audio content (Step 106) when the visual content corresponds to the keywords or the related keywords. The visual content may have a tag, a comment, and/or a meta-data field value, or field values, either the same as one or more of the keywords, comprising one or more of the keywords, or substantially similar to one or more of the keywords. Matching may be customized for strictness, number and length of materials to be aggregated, degree of fuzziness to employ for extended matching, words to be used as the keywords for searching and matching, words to be ignored for searching, and the vocabulary database to be used for extending the search results. Further, matching may be performed for visual content on a local storage device or for visual content on a networked storage device or web server. In other words, the method may search for the visual content related to the audio content locally, on the networked storage device, or on the web server, e.g. on the Internet, and download the visual content for integration in later processes.

As an optional step, the audio content and the visual content that are matched in Step 106 may be grouped and mixed to form audiovisual content (Step 108). Mixing may be customized for length of the audiovisual content, which of the audio content and visual content are to be used, which of the audio content and visual content are to be dropped, which are to be re-used, degree of re-use of the audio content and the visual content, post-processing effects to be applied, order of arrangement, format of the audiovisual content, and encoding method of the audiovisual content. The audiovisual content may be a multimedia production in the form of a static multimedia file, a digital stream for broadcast or distribution across networked devices or over the Internet, a multimedia optical disc, and/or an analog output in a magnetic storage.

As a further optional step, the audiovisual content generated in Step 108 may be played (Step 110). For example, the audiovisual content may be stored as a local file and played by a player software, or the audiovisual content may be generated on-the-fly and played by the player software.

In the above, Steps 102 and 104 may be omitted, and the keywords may be directly used to find the visual content matching the audio content. Likewise, the method may end at Step 106, without generating the audiovisual content as an output or playing the audiovisual content. Instead, the method may be utilized to generate a database describing highly-related audio and visual content.

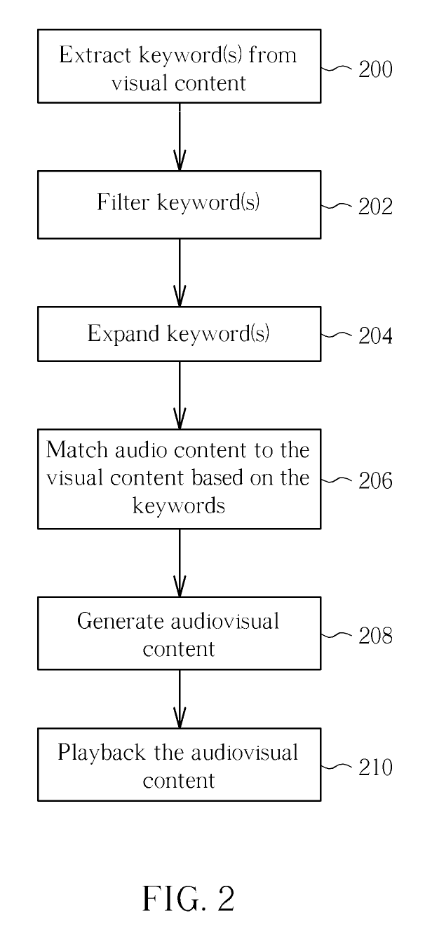

Please refer to FIG. 2, which is a diagram of a method of matching visual content with audio content according to another embodiment of the present invention. The method shown in FIG. 2 is similar to the method shown in FIG. 1. Keywords are extracted from visual content (Step 200). The keywords may be extracted from meta-data of the visual content, and may include artists, album, title, year, comments/tags, genre, director, screen play, publisher, rating, or casting of the visual content. The keywords may be encoded in the visual content, or may be stored on a local storage device or on a networked storage device, such as a web server. Once the keywords are extracted or received, the keywords may be filtered (Step 202) and expanded (Step 204) in much the same way as mentioned above for Step 102 and Step 104 in FIG. 1. For example, an image file may comprise a tag, “Christmas”, which may be utilized as the keyword. Utilizing the keyword, songs having meta-data comprising the word, “Christmas”, may be found to match. For example, a song may comprise the word, “Christmas”, in its title meta-tag, genre meta-tag, or album meta-tag. Then, the audio content may be matched to the visual content based on the keywords (Step 206), similar to Step 106 described above. Utilizing the audio content and the visual content matched by the method shown in FIG. 2, audiovisual content may be generated (Step 208), again similar to Step 108 described above.

Given a selection of visual content, e.g. a large number of images, a user may wish to display the images in a slideshow format. The method shown in FIG. 2 may also be utilized to add background music to the slideshow based on statistical information about the images. In other words, in Step 200, the keywords may be extracted from all of the images, and if repeated keywords are present among the keywords, e.g. “Frank Sinatra”, in Step 202, other keywords not repeated significantly may be filtered out, and a song, or songs, with the keywords “Frank Sinatra” in its artist meta-tag may be found in Step 206. Utilizing the song(s) found in Step 206, and the selection of visual content, in Step 208, the audio content and the visual content may be mixed to form the audiovisual content, e.g. the slideshow with background music. The slideshow may be output on-the-fly, or may be output as a static video file. In either case, the audiovisual content may be played immediately or at a later time (Step 210).

The methods described in the embodiments of the present invention make it very easy to match audio and visual content, and also to allow users to generate effective audiovisual content, such as presentations and slideshows, regardless of whether the user starts with a song or a selection of images. The audiovisual content may be outputted as a streaming video file, or as a static video file. Integration with the Internet and vocabulary databases further increases intuition and robustness of the methods. The matching may also be performed automatically in the background on an existing media library, making the embodiments of the present invention even more user friendly. The embodiments of the present invention save time by rapidly integrating audio and visual content for use in audiovisual content generation.

Those skilled in the art will readily observe that numerous modifications and alterations of the device and method may be made while retaining the teachings of the invention.

What is claimed is:

1. A method of matching audio content with visual content, the method comprising:
decoding meta-data of the audio content;
extracting a keyword from the meta-data of the audio content;
matching the visual content to the audio content when the keyword corresponds to the visual content; and
generating audiovisual content by mixing the audio content and the visual content.

2. The method of claim 1, further comprising:
ignoring text information other than the keyword when extracting the keyword from the audio content.

3. The method of claim 2, further comprising:
searching for the text information in a vocabulary database;
wherein ignoring the text information other than the keyword is ignoring the text information other than the keyword when the text information is found in the vocabulary database.

4. The method of claim 1, further comprising:
searching for a related keyword corresponding to the keyword; and
matching the visual content to the audio content when the related keyword corresponds to the visual content.

5. The method of claim 4, wherein searching for the related keyword is receiving the related keyword from an Internet-based search of the keyword.

6. The method of claim 5, wherein receiving the related keyword from the Internet-based search is extracting a user-generated comment or tag from a result of the Internet-based search.

7. The method of claim 4, wherein searching for the related keyword is searching for the related keyword in a vocabulary database.

8. The method of claim 1, further comprising:
searching for the visual content according to the keyword before matching the visual content to the audio content.

9. The method of claim 1, further comprising:
searching for lyrics corresponding to the audio content;
extracting a lyric keyword from the lyrics; and
matching the visual content to the audio content when the lyric keyword corresponds to the visual content.

10. The method of claim 1, further comprising:
extracting a keyword from the visual content;
wherein matching the visual content to the audio content when the keyword corresponds to the visual content is matching the visual content to the audio content when the keyword extracted from the audio content matches the keyword extracted from the meta-data of the visual content.

11. The method of claim 1, wherein matching the visual content to the audio content when the keyword corresponds to the visual content is matching at least one image to the audio content when the keyword corresponds to the at least one image.

12. The method of claim 1, wherein matching the visual content to the audio content when the keyword corresponds to the visual content is matching text to the audio content when the keyword corresponds to the text.

13. The method of claim 12, wherein matching the text to the audio content when the keyword corresponds to the text is matching a quote to the audio content when the keyword is a word of the quote.

14. The method of claim 1, further comprising playing the audiovisual content.

15. A method of matching visual content with audio content, the method comprising:
decoding meta-data from the visual content;
extracting a keyword from the meta-data;
matching the audio content to the visual content when the keyword corresponds to the audio content; and
generating audiovisual content by mixing the visual content and the audio content.

16. The method of claim 15, further comprising:
ignoring text information other than the keyword when extracting the keyword from the visual content.

17. The method of claim 16, further comprising:
searching for the text information in a vocabulary database;
wherein ignoring the text information other than the keyword is ignoring the text information other than the keyword when the text information is found in the vocabulary database.

18. The method of claim 15, further comprising:
searching for a related keyword corresponding to the keyword; and
matching the audio content to the visual content when the related keyword corresponds to the audio content.

19. The method of claim 18, wherein searching for the related keyword is receiving the related keyword from an Internet-based search of the keyword.

20. The method of claim 19, wherein receiving the related keyword from the Internet-based search is extracting a user-generated comment or tag from a result of the Internet-based search.

21. The method of claim 18, wherein searching for the related keyword is searching for the related keyword in a vocabulary database.

22. The method of claim 15, further comprising:
searching for the audio content according to the keyword before matching the audio content to the visual content.

23. The method of claim 15, further comprising:
searching for lyrics corresponding to the audio content;
extracting a lyric keyword from the lyrics; and
matching the audio content to the visual content when the lyric keyword corresponds to the keyword.

24. The method of claim 15, wherein matching the audio content to the visual content when the keyword corresponds to the audio content is matching at least one song to the visual content when the keyword corresponds to the at least one song.

25. The method of claim 15, further comprising:
extracting a keyword from meta-data of the audio content;
wherein matching the audio content to the visual content when the keyword corresponds to the audio content is matching the audio content to the visual content when the keyword extracted from the visual content matches the keyword extracted from the meta-data of the audio content.

26. The method of claim 15, further comprising playing the audiovisual content.
